(19) United States
(12) Patent Application Publication
(10) Pub. No.: US 2001/0053222 A1
(43) Pub. Date: Dec. 20, 2001

(54) Data processing apparatus and method

(76) Inventors: Satoru Wakao, Tokyo (JP); Keiichi Iwamura, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/875,965

(22) Filed: Jun. 8, 2001

(30) Foreign Application Priority Data
Jun. 14, 2000 (JP) 178294/2000

(51) Int. Cl. H04L 9/00

(52) U.S. Cl. 380/43; 380/262

(57) ABSTRACT

A data processing method comprising the steps of inputting a plurality of object data, encrypting at least a predetermined portion of the object data using first key data to produce encrypted object data, generating seed information which allows the first key data to be obtained therefrom, multiplexing the plurality of object data and the encrypted object data to generate a data stream, and individually transmitting the seed information and the data stream.

### BACKGROUND OF THE INVENTION

1. Field of the Invention

The present invention relates to data processing apparatuses and methods, and more particularly to encryption and descramble processing for protecting intellectual property rights of information data distributed over a network.

2. Description of the Related Art

Recently, by the efforts made by ISO (International Organization for Standardization), MPEG-4 (Moving Picture Experts Group phase 4) has become standardized as a method of coding video data and audio data, the respective coded data being treated as objects, and where the objects are composed into a single bit stream of so-called multimedia data for transmission.

On the receiver side, the MPEG-4 video data and audio data are reproduced in association with each other. The MPEG-4 system, in which data is treated as objects as mentioned above, readily allows disintegrating of the received bit stream into individual objects and the reassembling of the objects as desired. If any copyright is assigned to the objects, in order to protect the copyright, reproducing restrictions must be imposed on the entirety or part of the data, for example, by means of encryption.

Unlike conventional multimedia streams, MPEG-4 data streams allow a plurality of video scenes and video objects to be independently transmitted and received within a single stream. Similarly, a plurality of audio objects are allowed to be independently transmitted and received within a single stream.

In order to compose the objects into a scene, scene description information is provided in BIFS (Binary Format For Scenes), which is an extended version of VRML (Virtual Reality Modeling Language). BIFS describes the scene in binary numbers, and the scene is produced in accordance therewith.

The objects which are composed into the scene are individually coded in their respective optimal ways on the transmitter side; thus, on the receiver side, the objects are individually decoded, and based on the BIFS description, the time bases of the individual objects are synchronized with the internal time base of the reproduction apparatus, so that the individual objects are composed into the scene for being outputted.

As described above, MPEG-4 performs coding and decoding on an object-by-object basis. Since the data to be coded and decoded is obviously digital data, copies thereof can readily be made. Unlike copies of analog data, copies of digital data are exactly the same as the original data. It is a critical concern for the copyright holder if copies of the original data with copyright are widely distributed as pirated editions.

As a measure against illegal copying of data, in DVDs (Digital Video Disks), content data is generally stored in an encrypted form. According to that measure, the content data is encrypted using a hierarchical combination of a master key Km specific to each company, entity, or proprietor, a disk key Kd specific to each disk, and a title key Kt specific to each title of contents on the disk.

More specifically, when a DVD disk is manufactured, data E(Km, Kd) is generated by encrypting the disk key Kd using the master key Km, data E(Kd, Kt) is generated by encrypting the title key Kt using the disk key Kd, and data E(Kt, data) is generated by encrypting the content data using the title key Kt. The data E(Km, Kd), E(Kd, Kt), and E(Kt, data) are stored on the DVD disk. At this time, the data E(Km, Kd) and E(Kd, Kt) are stored in areas which are not directly accessible by, i.e., not accessible via a logic file system of, a personal computer, etc.

The reproduction apparatus first descrambles the data E(Km, Kd) using the master key Km which the reproduction apparatus owns. Because the data E(Km, Kd) has been generated by encrypting the disk key Kd using the master key Km, the disk key Kd is obtained by the descrambling. Then, the data E(Kd, Kt) is descrambled using the disk key Kd. Because the data E(kd, Kt) has been generated by encrypting the title key Kt using the disk key Kd, the title key Kt is obtained by the descrambling. Lastly, the data E(Kt, data) is descrambled using the title key Kt. Because the data E(Kt, data) has been generated by encrypting the content data using the title key Kt, the content data is obtained by the descrambling. The descrambled content data is decoded so that corresponding images and sounds are outputted.

In accordance with the encryption method described above, even if the data on the DVD disk is illegally copied, because the data E(Km, Kd) and E(Kd, Kt) is stored in areas which are not directly accessible by a personal computer, etc., the encrypted content data E(Kt, data) is not allowed to be descrambled. The encryption method thus functions as a measure against illegal copying of the data.

With the recent development of communications technology, such as the Internet, it is predicted that methods of data distribution will shift from the conventional storage media based approach to a network-oriented approach which typically uses the Internet.

In the new data distribution approach, communication is bilateral; i.e., communication is established between nodes connected via a network, and after a mutual authentication process, data is transmitted from the requested node to the requesting node. The authentication process readily allows particular data to be transmitted to a particular receiver. Thus, the user is allowed to quickly obtain desired or latest data, for example, at home or at an office, while the distributor of the data will enjoy various benefits, in particular, eliminated cost for transportation of the storage media.

Obviously, when MPEG-4 data which deals with a plurality of object data is distributed over a network, copyright of the data must be protected.

However, the measure against illegitimate copying, described above, only deals with content data stored and distributed on a storage medium such as a DVD disk and read from the storage medium for playback in a reproduction apparatus. Thus, the measure is not applicable to content data distributed over a network only to an authenticated user.

Hitherto, no concrete proposals have been made as to methods and apparatuses for efficiently and adequately protecting intellectual property rights, in particular, copyright protection, for object data distributed over a network.

### SUMMARY OF THE INVENTION

Accordingly, it is an object of the present invention to provide a data processing apparatus and method which serve to efficiently and adequately protect intellectual property rights, in particular, copyrights, of object data distributed over a network.

To this end, the present invention, in one aspect thereof, provides a data processing apparatus including a) an input unit for inputting a plurality of object data; b) a first encryption unit for encrypting at least a predetermined portion of the object data using first key data to produce encrypted object data; c) a generating unit for generating seed information which allows the first key data to be obtained therefrom; d) a multiplexing unit for multiplexing the plurality of object data and the encrypted object data to generate a data stream; and e) a transmitting unit for individually transmitting the seed information and the data stream.

In another aspect, the present invention provides a data processing apparatus including a) a receiving unit for individually receiving a data stream and seed information, the data stream having been generated by the multiplexing of a plurality of object data including object data encrypted using first key data, the seed information allowing the first key data, which is required in descrambling the encrypted object data, to be obtained therefrom; b) a demultiplexing unit for demultiplexing the data stream received by the receiving unit into individual object data; c) an obtaining unit for obtaining the first key data from the seed information received by the receiving unit; and d) a descrambling unit for descrambling the encrypted object data using the first key data obtained by the obtaining unit.

In another aspect, the present invention provides a data processing method including the steps of a) inputting a plurality of object data; b) encrypting at least a predetermined portion of the object data using first key data (first encrypting step) to produce encrypted object data; c) generating seed information which allows the first key data to be obtained therefrom; d) multiplexing the plurality of object data and the encrypted object data to generate a data stream; and e) individually transmitting the seed information and the data stream.

In another aspect, the present invention provides a data processing method including the steps of a) individually receiving a data stream and seed information, the data stream having been generated by the multiplexing of a plurality of object data including object data encrypted using first key data, the seed information allowing the first key data, which is required to descramble the encrypted object data, to be obtained therefrom; b) demultiplexing the data stream received in the receiving step into individual object data; c) obtaining the first key data from the seed information received in the receiving step; and d) descrambling the encrypted object data using the first key data obtained in the obtaining step.

In another aspect, the present invention provides a computer readable storage medium storing program code for performing a data processing method comprising the steps of a) inputting a plurality of object data; b) encrypting at least a predetermined portion of the object data using first key data to produce encrypted object data; c) generating seed information which allows the first key data to be obtained therefrom; d) multiplexing the plurality of object data and the encrypted object data to generate a data stream; and e) individually transmitting the seed information and the data stream.

In another aspect, the present invention provides a computer readable storage medium storing program code for performing a data processing method comprising the steps of a) individually receiving a data stream and seed information, the data stream having been generated by the multiplexing of a plurality of object data including object data encrypted using first key data, the seed information allowing the first key data, which is required to descramble the encrypted object data, to be obtained therefrom; b) demultiplexing the data stream received in the receiving step into individual object data; c) obtaining the first key data from the seed information received in the receiving step; and d) descrambling the encrypted object data using the first key data obtained in the obtaining step.

In another aspect, the present invention provides a software program including program code for performing a data processing method comprising the steps of a) inputting a plurality of object data; b) encrypting at least a predetermined portion of the object data using first key data to produce encrypted object data; c) generating seed information which allows the first key data to be obtained therefrom; d) multiplexing the plurality of object data and the encrypted object data to generate a data stream; and e) individually transmitting the seed information and the data stream.

In another aspect, the present invention provides a software program including program code for performing a data processing method comprising the steps of a) individually receiving a data stream and seed information, the data stream having been generated by the multiplexing of a plurality of object data including object data encrypted using first key data, the seed information allowing the first key data, which is required to descramble the encrypted object data, to be obtained therefrom; b) demultiplexing the data stream received in the receiving step into individual object data; c) obtaining the first key data from the seed information received in the receiving step; and d) descrambling the encrypted object data using the first key data obtained in the obtaining step.

Further objects, features and advantages of the present invention will become apparent from the following description of the preferred embodiments with reference to the attached drawings.

### BRIEF DESCRIPTION OF THE DRAWINGS

FIG. 1 is a block diagram showing the overall construction of a common MPEG-4 reproduction apparatus;

FIG. 2 is a diagram showing the configuration of a content distribution system which is used in embodiments of the present invention;

FIG. 3 is a block diagram of a transmitter apparatus according to an embodiment of the present invention;

FIG. 4 is a block diagram of a reproduction apparatus according to an embodiment of the present invention;

FIG. 5 is a flowchart of a descramble processing method performed by an IMPM control unit in the reproduction apparatus according to FIG. 4;

FIG. 6 is a schematic diagram of the content distribution system which is used in the embodiments of this invention;

FIG. 7 is a diagram showing an example of a bitstream according to the MPEG-4 coding method; and

FIG. 8 is a diagram showing an example of an IPMP descriptor.

### DESCRIPTION OF THE PREFERRED EMBODIMENTS

Preferred embodiments of the present invention will now be described with reference to the accompanying drawings.

The description will be directed first to the overall construction of a common MPEG-4 reproduction apparatus, then to an example of processing in a transmitter apparatus according to the present invention, then to an example of descramble processing in a reproduction apparatus according to the present invention, and lastly to an example of the operation of the reproduction apparatus.

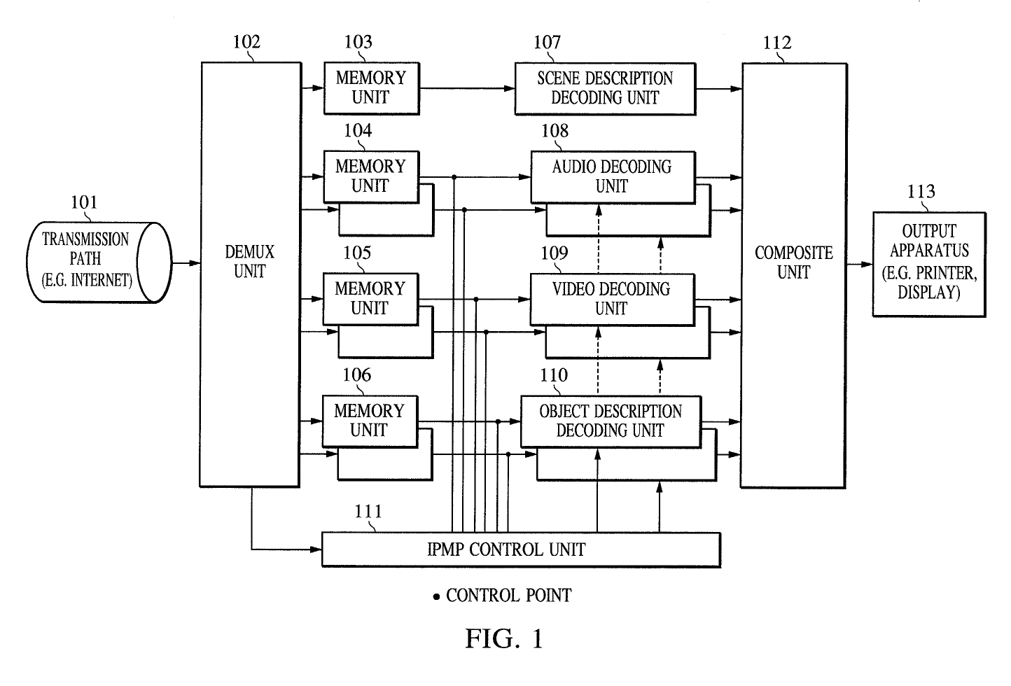

FIG. 1 is a block diagram showing the overall construction of an MPEG-4 reproduction apparatus. Referring to FIG. 1, a transmission path 101 is a data path such as a computer bus and various networks, for example, the Internet, through which MPEG-4 bitstream data is transmitted. In addition to being a communications channel, the transmission path 101 may also serve as an interface between the reproduction apparatus and a storage apparatus (not shown in FIG. 1) such as a CD-ROM drive, a DVD-ROM drive, and a DVD-RAM drive.

In the reproduction apparatus, MPEG-4 bitstream data distributed via a network, or received from the storage apparatus (not shown in FIG. 1), is inputted to a demux (demultiplexing) unit 102. In the demux unit 102, the MPEG-4 bitstream data is demultiplexed into, for example, scene description information data, audio object data, video object data, and object description data, which are then inputted to corresponding memory units 103 to 106, respectively.

The audio object data preferably has been (on the transmitting end, described below) efficiently coded by, for example, CELP (Code Excited Linear Prediction) coding, or TWINVQ (Transform domain Weighted INterleave Vector Quantization) coding, which are well known in the art. Similarly, the video object data is efficiently coded in accordance with, for example, MPEG-4 or H.263.

The object data in the memory units 104 to 106 are respectively inputted to corresponding decoding units 108 to 110. The decoding units 108 to 110 respectively decode the audio object data, the video object data, and the object description data. The scene description data in the memory unit 103 is directly inputted to the scene description decoding unit 107 for decoding.

As shown in FIG. 1, the MPEG-4 reproduction apparatus includes a plurality of audio decoding units 108, a plurality of video decoding units 109, and a plurality of object description decoding units 110, so that different types of audio object data, video object data, and object description data in MPEG-4 bitstream data are allowed to be decoded in the respective ones of the units.

Then, the audio object data, the video object data, and the object description data, respectively decoded in the memory units 108 to 110, are composed and graphic-processed in a composite unit 112 based on scene description information data decoded and outputted by the scene description decoding unit 107. A data sequence thus obtained is outputted to an output apparatus 113, such as a display or a printer, and is thereby viewed by an operator.

If any reproduction control is required in order to protect a copyright of individual object data, including audio and video data, constituting scenes, IPMP (Intellectual Property Management and Protection) data is used. The IPMP data is transmitted as part of IPMP information included within the received data.

An IPMP control unit 111, based on the IPMP data included in the IPMP information received from the demux unit 102, stops the stream at control points, when necessary or accesses the decoding units 108 to 110 to stop decoding operations, as required.

For example, when the IPMP control unit 111 determines, based on the IPMP information, that the user is not allowed to view particular data (i.e., the data outputted by 104, 105, or 106), the data is not decoded and therefore is not played back (the units 108, 109, and 110 are selectively disabled). Thus, copyright of the data can be protected.

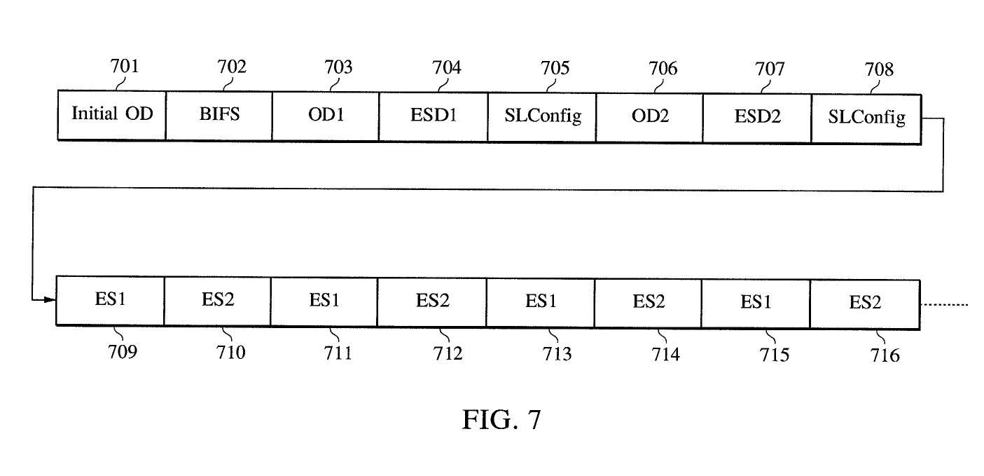

FIG. 7 is a diagram showing the data structure of a bitstream in accordance with the MPEG-4 coding method.

Referring to FIG. 7, 701 is an initial object descriptor in which properties (profiles, etc.) of the entire bitstream are stored, and 702 is a BIFS stream in which scene information is stored.

703 is an object descriptor (hereinafter referred to as OD) which describes properties of objects subsequently stored. In this example, two OD (OD1 (703) and OD2 (706)) are provided. Each of the OD are allowed to describe a plurality of elementary stream descriptors (hereinafter referred to as ESD (704 and 707)) indicating the properties of media streams (also called elementary streams and hereinafter referred to as ES). The OD respectively includes ES1 (709, 711, 713, and 715) and ES2 (710, 712, 714, and 716).

According to the MPEG-4 coding method (ISO/IEC 14496-1), the IPMP information is allowed to be added to each of the OD and ES. The IPMP information itself is described in what is called an IPMP descriptor. The syntax of IPMP is not specifically defined, allowing flexible syntax; however, the IPMP system type number registered at an RA (Registration Authority) must be included.

Each of the descriptors for OD, ESD, and IPMP, described above, must be disposed at the beginning of streams preceding the elementary streams, as shown in FIG. 7. However, each of the descriptors may be added, deleted, or changed by inserting upstream commands in the middle of the streams.

Each of the elementary streams is packetized into sync layer packets (SL packets). SLConfig descriptors (SLConfig (705 and 708) which describe the structure of the SL packets are also added to each of the ESD.

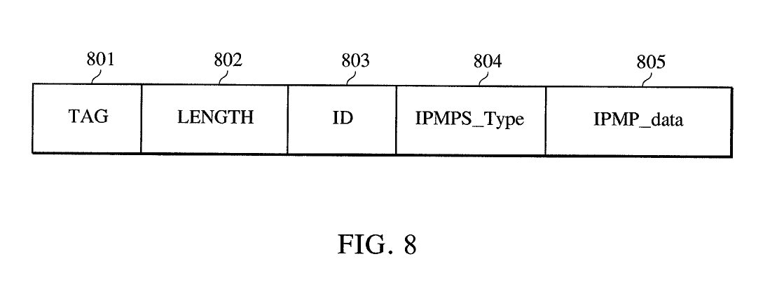

FIG. 8 is a diagram showing the data structure of an IPMP descriptor.

Referring to FIG. 8, 801 is a descriptor tag which indicates the type of the descriptor. 802 is a length field indicating the length (i.e., the number of bytes) of the entire descriptor. 803 indicates a descriptor ID. 804 is an IPMPS_Type field, indicating a security type number as described earlier. 805 is an IPMP_data field, in which data required for reproduction control for the purpose of copyright protection is stored. In this embodiment, key information (E(Kw, Ks) which will be described later) for use in encrypting the video object data is stored in the IPMP_data field.

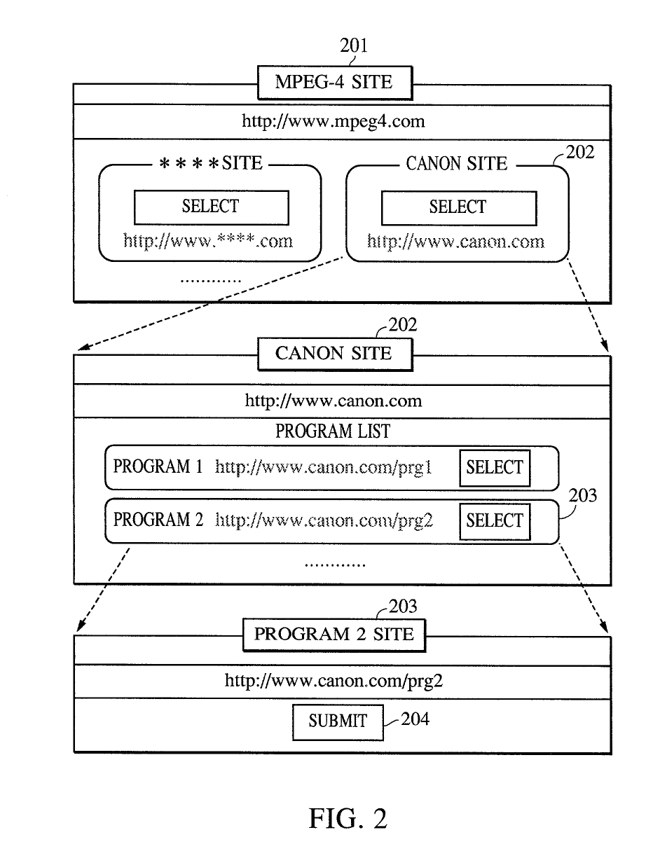

Now, an example of processing in a transmitter apparatus according to an embodiment of the present invention will be described below with reference to FIGS. 2, 3, and 6.

First, an example of a content distribution system which used in this embodiment, and a procedure for the user to receive MPEG-4 bitstream data will be described.

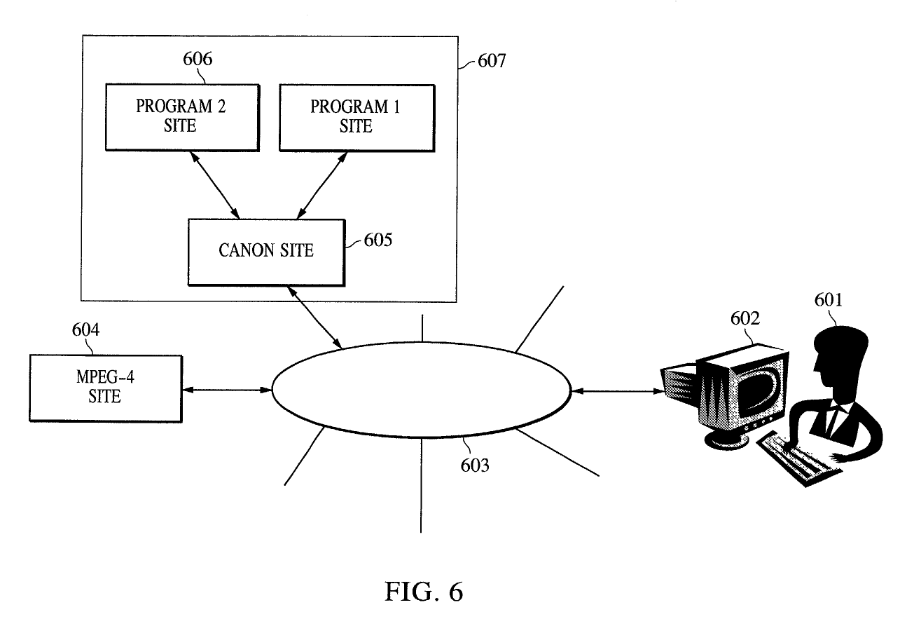

One of the proposed applications of MPEG-4 is content distribution over computer networks. In this embodiment, by way of example, an MPEG-4 content distribution system over the Internet, as shown in FIG. 6, is employed. The content distribution system is of the on-demand type, in which, when a reproduction apparatus (i.e., the user) issues a request, the transmitter apparatus transmits the requested data to the user.

A user 601, who wishes to receive MPEG-4 bitstream data, initially accesses an MPEG-4 site 604 using a personal computer 602 (the reproduction apparatus). The MPEG-4 site 604 is a portal site constituted of addresses of (i.e., links to) web sites of various companies, as indicated by 201 in FIG. 2.

The user 601 selects a desired company, for example, the company indicated by 202 in FIG. 2, and thereby accesses, for example, a CANON site 605. Then, the user selects a desired program in the CANON site 605, for example, the program 2 indicated by 203 in FIG. 2, and thereby accesses a program 2 site 606. The user then clicks on a submit button 204, so that MPEG-4 bitstream data corresponding to the program 2 will be transmitted to the reproduction apparatus (computer 602).

The transmitter apparatus 607 edits various object data, including video object data, audio object data, and still picture object data, to thereby generate MPEG-4 bitstream data for a program. If any object data requires viewing restrictions by way of encryption, the transmitter apparatus 607 performs restriction settings and generates various relevant data. (It mentions later for details.) The MPEG-4 bitstream data for the program, which has thus been created, is stored in the transmitter apparatus 607, and is transmitted in response to a request from the reproduction apparatus (computer 602), in this case, in response to the clicking on the submit button 204.

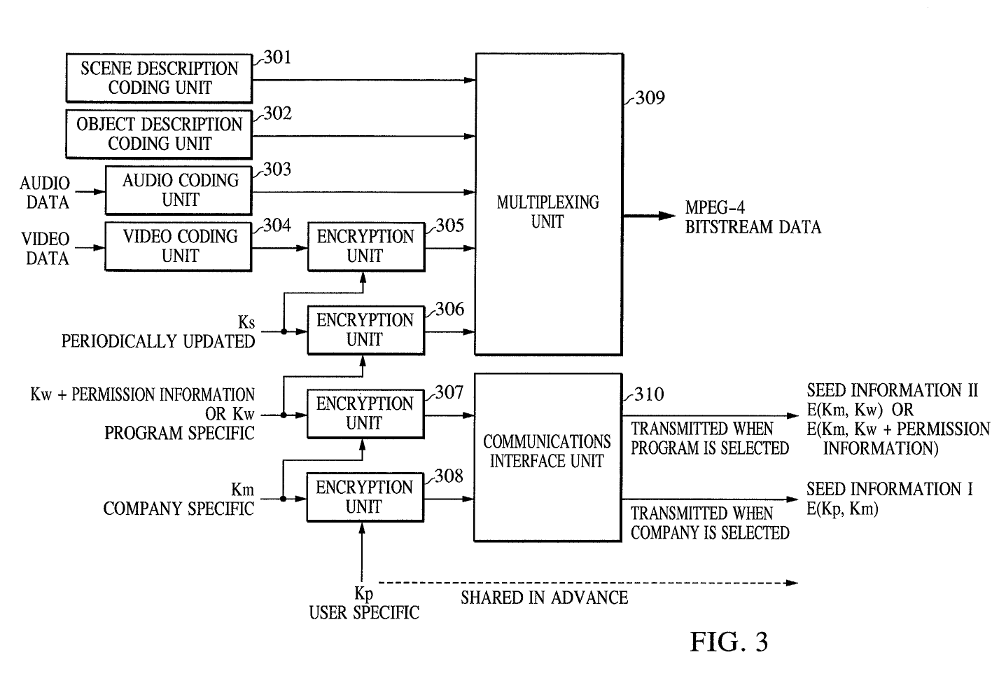

Next, a transmitter apparatus according to the present embodiment will be described with reference to FIG. 3.

In this embodiment, it is assumed that the content distribution system described above is employed, and that, of various object data constituting MPEG-4 bitstream data, only video object data needs to be encrypted. More specifically, the video object data is scrambled using key information generated from copyright management information (described below) and seed information, and the video object data is descrambled in a reproduction apparatus using the key information, as will be described below.

The copyright management information is included in IPMP information, the seed information is obtained during communications between the reproduction apparatus and the transmitter apparatus via a network, and the key information is used for encryption of the video object data.

In this embodiment, four keys preferably are used in a hierarchical combination; namely, a user key Kp specific to each reproduction apparatus, a master key Km specific to each company or entity associated with the data, a work key Kw specific to each program, and key information Ks for encryption of object data.

A user, who wishes to receive MPEG-4 bitstream data, initially accesses the MPEG-4 site 604, and selects a desired company. At this time, the transmitter apparatus performs an authentication process with the reproduction apparatus using the user key Kp, identifying the reproduction apparatus which has accessed the site. Then, the transmitter apparatus generates, in an encryption unit 308 (FIG. 3), data E(Kp, Km) by encrypting the master key Km using the user key Kp, the data E(Kp, Km) serving as seed information I. The transmitter apparatus then transmits the seed information I via a communications interface unit 310.

The user then selects a desired program. At this time, the transmitter apparatus generates, in an encryption unit 307, data E(Km, Kw) by encrypting the work key Kw using the master key Km, the data E(Km, Kw) serving as seed information II. The transmitter apparatus then transmits the seed information II via the communications interface unit 310. The seed information I and II is important information which is used to descramble object data. Thus, it is preferable to use, for example, SSL (Secure Socket Layer), which is an encryption standard for communications between a client and a server.

Prior to communicating the video object data to the reproduction apparatus, the transmitter apparatus encrypts the video object data, generates the copyright management information, and multiplexes various object data, thereby generating MPEG-4 bitstream data. More specifically, video data is inputted to a video coding unit 304 to be coded into video object data V_data, and the video object data V_data is encrypted in an encryption unit 305 using the key information Ks, whereby E(Ks, V_data) is obtained.

The key information Ks is periodically updated, so that even if the key information Ks is undesirably made known to a third party, the problem is restricted only to data encrypted in a particular period. Preferably, the key information Ks is updated as frequently as possible. The key information Ks is obtained, for example, by generating pseudo-random numbers, which serves to enhance security.

In an encryption unit 306, the key information Ks is encrypted using the work key Kw, whereby the copyright management information E(Kw, Ks) is obtained. The copyright management information E(Kw, Ks) constitutes part of the IPMP information.

Data other than the video data, such as audio data, is coded in respective coding units, such as an audio coding unit 303, and is forwarded to a multiplexing unit 309. The scene description information data, which includes information regarding location and timing information for reproduction of objects, and the object description data, which includes information regarding the object data, is respectively coded in the scene description coding unit 301 and the object description coding unit 302, and is then forwarded to the multiplexing unit 309. The multiplexing unit 309 multiplexes the video object data which has been encrypted using the key information Ks, i.e., E(Ks, V_data), the scene description information data, the audio object data, the object description data, the IPMP information, etc. to generate MPEG-4 bitstream data. The MPEG-4 bitstream data is transmitted to the reproduction apparatus in response to the user clicking on the submit button 204 of a corresponding program.

By the above procedure, the reproduction apparatus receives the MPEG-4 bitstream data constituted by the encrypted video object data, the IPMP information, the object data including the audio object data, the scene description information data, the object description data, etc., and also receives the seed information I and II prior to receiving the MPEG-4 bitstream data.

Information regarding Ks, Kw, Km, and Kp is stored in a memory unit which is not shown in FIG. 3. When the user clicks on the submit button 204, and the transmitter apparatus receives a corresponding signal, in response thereto, a controller (not shown) reads the information regarding Ks, Kw, Km, and Kp from the memory unit, and performs the encryption processing described above.

The reproduction apparatus obtains the key information Ks using the seed information I and II and the copyright management information included in the IPMP information, and descrambles the encrypted video object data using the key information Ks. The descrambling procedure will now be described below more in detail.

Next, a method of descrambling in the reproduction apparatus, according to an embodiment of the present invention, will be described by way of example, and in conjunction with a description of the manner in which information is exchanged between the transmitter apparatus and reproduction apparatus.

In the description of this embodiment, it is assumed that the content distribution system (FIG. 6) described earlier is employed. Of various object data constituting the MPEG-4 bitstream data, only video object data is assumed to be encrypted. The video object data is descrambled using key information obtained from copyright management information and seed information, as will now be described.

In the content distribution system, the reproduction apparatus accesses the MPEG-4 site 201 to select a desired company, at which time the reproduction apparatus receives the seed information I from the transmitter apparatus in the above-described manner. The seed information I is data E(Kp, Km) generated by encrypting a company-specific master key Km using a user-specific user key Kp. The user key Kp is shared in advance between the reproduction apparatus and the transmitter apparatus.

The transmitter apparatus identifies the reproduction apparatus which has accessed the site of the company by way of mutual authentication, in a known manner. Thus, the transmitter apparatus generates the seed information I using the key Kp corresponding to the reproduction apparatus, and transmits the seed information I to the reproduction apparatus, as described above.

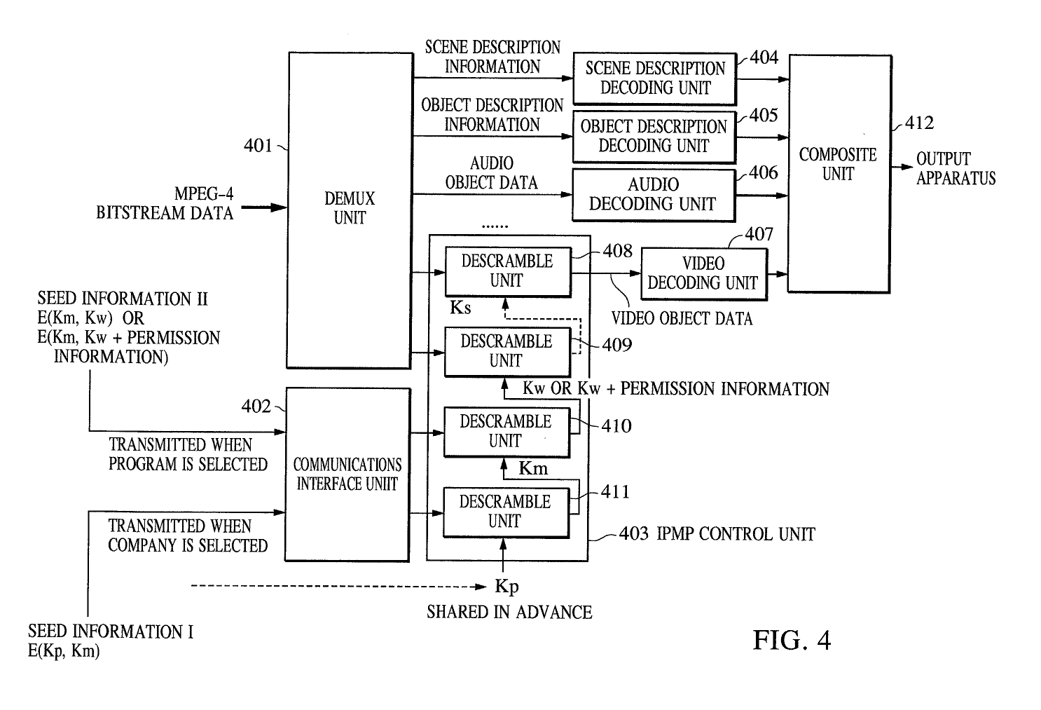

The user then selects a desired program, at which time the reproduction apparatus receives seed information II from the transmitter apparatus, in the above described manner. The seed information II is data E(Km, Kw) generated by encrypting the work key Kw using the master key Km. As described earlier, security can be enhanced by transmitting the seed information I and II using, for example, SSL. In the reproduction apparatus (FIG. 4), the seed information I and II is inputted to, via a communications interface unit 402, to descramble units 411 and 410, respectively.

The user of the reproduction apparatus then clicks on the submit button 204, so that MPEG-4 bitstream data constituting video object data encrypted using the key information Ks, i.e., the data E(Ks, V_data), the scene description information data, the audio object data, the object description data, the IPMP information, etc. is transmitted from the transmitter apparatus to the reproduction apparatus. The IPMP information includes the copyright management information E(Kw, Ks) generated by encrypting the key information Ks using the work key Kw. As described earlier, security can be enhanced by periodically updating the key information Ks.

The received MPEG-4 bitstream data is demultiplexed into individual object data in a demux unit 401 of the reproduction apparatus. Then, the individual object data, except for the video object data, is decoded in respective decoding units 404 to 406, composed in a composite unit 112 in accordance with the scene description information data, and is outputted to a reproduction apparatus (not shown).

The description below describes descrambling of the encrypted video data by way of example.

In the reproduction apparatus, a descramble unit 411 descrambles the seed information I originally transmitted when the desired company was selected, using the user key Kp to which the reproduction apparatus is assigned. Since the seed information I is the data E(Kp, Km) generated by encrypting the master key Km using the user key Kp, the master key Km is obtained by the descrambling.

Then, a descramble unit 410 descrambles the seed information II originally transmitted when the desired program was selected, using the master key Km obtained by the above descrambling. Since the seed information II is the data E(Km, Kw) generated by encrypting the work key Kw using the master key Km, the work key Kw is obtained by the descrambling.

Then, the reproduction apparatus descrambles, in a descramble unit 409, the copyright management information in the IPMP information included in the MPEG-4 bitstream data, using the work key Kw obtained by the above descrambling. Since the copyright management information is the data E(Kw, Ks) generated by encrypting the key information Ks using the work key Kw, the key information Ks is obtained by the descrambling.

Although the seed information II has been described hereinabove as the data E(Km, Kw) generated by encrypting the work key Kw using the master key Km, alternatively, the seed information II may be data E(Kw+permission information). The permission information is associated with each program, and describes conditions regarding age, locality, etc. which are required for permission of viewing the program. The permission information is generated by the transmitter apparatus. In this case, the data E(Kw+permission information) is outputted from the descramble unit 410 and inputted to the descramble unit 409.

The descramble unit 409 determines whether the user is allowed to view the program based on the permission information, and the age, locality, etc. preset and prestored in the reproduction apparatus. If it is determined that the user is not allowed to view the program, the descramble unit 409 does not output the key information Ks to descramble unit 408. In this manner, control on a program by program basis is allowed.

Then, the descramble unit 408 descrambles the encrypted video object data transmitted as part of the MPEG-4 bitstream data and demultiplexed in demux unit 401, using the key information ks obtained by the above descrambling in unit 409. The encrypted video object data is the data E(Ks, V_data) generated by encrypting the video object data using the key information Ks, the video object data is obtained by the descrambling.

Although the embodiment has been described in the context of only video object data being encrypted, it is to be understood that it also is within the scope of this invention for other types of object data such as audio object data, text object data, and still picture object data, to be encrypted/decrypted in a similar manner, using suitable encryption/decryption techniques.

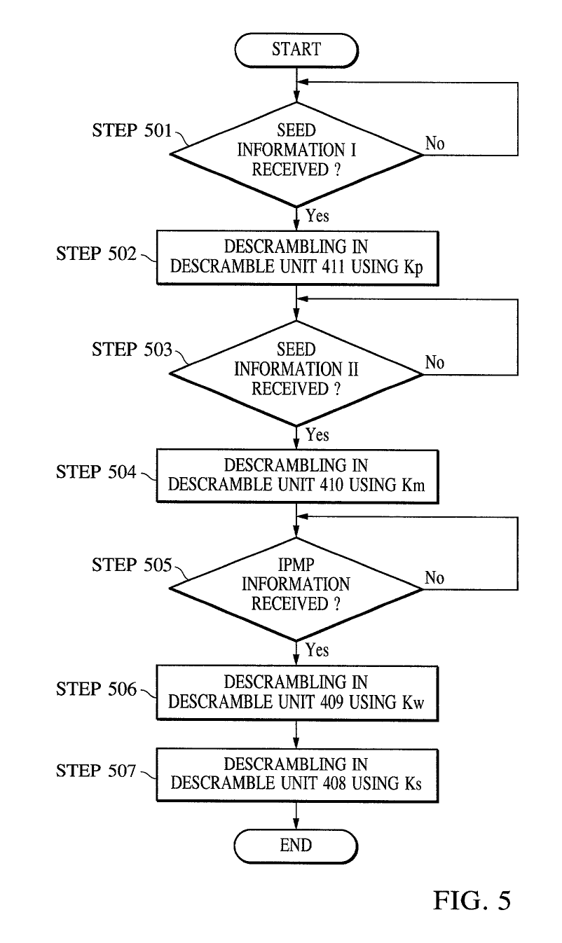

An example of descramble processing performed by an IPMP control unit 403 in the reproduction apparatus will be described below with reference to FIG. 4 and the flowchart in FIG. 5. Again, it is assumed that only video object data is encrypted.

FIG. 5 is a flowchart of a descramble processing technique performed by the IPMP control unit 403 that includes the descramble unit 408, the descramble unit 409, the descramble unit 410, and the descramble unit 411.

In step 501, it is determined whether seed information I has been inputted to the descramble unit 411. If the seed information I has been inputted, the processing proceeds to step 502, and if not, the processing keeps waiting for an input of the seed information I.

Then, in step 502, the seed information I which has been inputted is descrambled using the user key kp of the reproduction apparatus. Since the seed information I is the data E(Kp, Km) generated by encrypting the master key Km using the user key Kp, the master key Km is obtained by the descrambling.

Then, in step 503, it is determined if seed information II has been inputted to the descramble unit 410 from the communications interface unit 402. If the seed information II has been inputted, the processing proceeds to step 504, and if not, the processing keeps waiting for an input of the seed information II.

Then, in step 504, the seed information II which has been inputted is descrambled in the descramble unit 410 using the master key Km obtained in step 502. Since the seed information II is the data E(Km, Kw) generated by encrypting the work key Kw using the master key Km, the work key Kw is obtained by the descrambling.

Then, in step 505, it is determined whether the copyright management information has been inputted from the demux unit 401. If the copyright management information has been inputted, the processing proceeds to step 506, and if not, the processing keeps waiting for an input of the copyright management information.

Then, in step 506, the copyright management information which has been inputted is descrambled in the descramble unit 409 using the work key Kw obtained in step 504. Since the copyright management information is the data E(Kw, Ks) obtained by encrypting the key information Ks using the work key Kw, the key information Ks is obtained by the descrambling.

Then, in step 507, the encrypted video object data which has been inputted is descrambled in unit 408 using the key information Ks obtained in step 506. Since the encrypted video object data is the data E(Ks, V_data) generated by encrypting the video object data using the key information Ks, the video object data is obtained by the descrambling.

Although this embodiment has been described in the context of only video object data being encrypted/decrypted, it is to be understood that it also is within the scope of this invention to encrypt/decrypt other types of object data such as audio object data, text object data, and still picture object data, using suitable encryption/decryption techniques.

Using the above method, when MPEG-4 data which involves reproducing restrictions due to copyright issues is preferably transmitted and received via a network, the transmitter side encrypts the data and performs relevant processing for copyright protection, and on the receiver side, only an authenticated person, i.e., a legitimate, authorized user, is allowed to obtain information which is required for descrambling the encrypted data and to thereby reproduce decrypted video data, audio data, etc.

### OTHER EMBODIMENTS

The present invention may be applied either to a system including a plurality of apparatuses such as a host computer, an interface apparatus, a reader, and a printer, or to a single apparatus such as a video camera and a digital VTR.

Also, it is within the spirit and scope of the present invention that a software program, which controls various devices so as to implement the functionality described in the above embodiments, is installed on a computer in an apparatus connected to the devices or within the system, so that the devices are controlled by the computer (i.e., CPU or MPU) operating in accordance with the software program.

In this case, the software program itself achieves the functionality described in the above embodiments. Thus, the software program, the program codes of the software program, and a unit for supplying the program codes to a computer, for example, a storage medium storing the program codes, are each within the scope of the present invention.

The types of storage media for storing the program codes may include, for example, floppy disks, hard disks, optical disks, magneto-optical disks, CD-ROMs, DVD-ROMs, and non-volatile memory cards.

In addition to the case where the programs codes are executed by the computer, it is also within the spirit and scope of the present invention that the program codes are executed by an operating system or application programs on the computer, for achieving the functionality described in the above embodiments.

Furthermore, it is also within the spirit and scope of the present invention that the program codes are stored in an extension board on a computer or an extension unit connected to the computer, a CPU, etc. provided on the extension board or in an extension unit executing part of or the entire processing according to the program codes, thereby achieving the functionality described in the above embodiments.

The present invention, which has been described hereinabove, allows efficient and adequate protection of intellectual property rights, in particular, copyrights, of data transmitted over networks.

While the present invention has been described with reference to what are presently considered to be the preferred embodiments, it is to be understood that the invention is not limited to only the disclosed embodiments. On the contrary, the invention is intended to cover various modifications and equivalent arrangements included within the spirit and scope of the appended claims. The scope of the following claims is to be accorded the broadest reasonable interpretation so as to encompass all such modifications and equivalent structures and functions.

What is claimed is:

1. A data processing apparatus comprising:
a) input means for inputting a plurality of object data;
b) first encryption means for encrypting at least a predetermined portion of the object data using first key data to produce encrypted object data;
c) generating means for generating seed information which allows said first key data to be obtained therefrom;
d) multiplexing means for multiplexing said plurality of object data and the encrypted object data to generate a data stream; and
e) transmitting means for individually transmitting said seed information and said data stream.

2. A data processing apparatus according to claim 1, wherein said first key data periodically changes.

3. A data processing apparatus according to claim 1, further comprising second encryption means for encrypting said first key data using second key data, wherein said first key data encrypted by said second encryption means is multiplexed by said multiplexing means.

4. A data processing apparatus according to claim 3, further comprising third encryption means for encrypting said second key data using third key data, wherein the encrypted second key data is included in said seed information.

5. A data processing apparatus according to claim 4, further comprising fourth encryption means for encrypting said third key data using fourth key data, wherein the encrypted third key data is included in said seed information.

6. A data processing apparatus according to claim 1, wherein said input means further comprises coding means for individually coding said plurality of object data.

7. A data processing apparatus according to claim 6, wherein said coding means performs coding by a coding method conforming to MPEG-4.

8. A data processing apparatus according to claim 6, wherein said plurality of object data includes at least audio object data, video object data, and scene description information data for enabling the composing of said audio object data and said video object data.

9. A data processing apparatus according to claim 1, wherein said data stream includes intellectual property management and protection (IPMP) data for protecting an intellectual property right of the encrypted object data.

10. A data processing apparatus comprising:
a) receiving means for individually receiving a data stream and seed information, said data stream having been generated by the multiplexing of a plurality of object data including object data encrypted using first key data, said seed information allowing said first key data, which is required in descrambling the encrypted object data, to be obtained therefrom;
b) demultiplexing means for demultiplexing said data stream received by said receiving means into individual object data;
c) obtaining means for obtaining said first key data from said seed information received by said receiving means; and
d) descrambling means for descrambling the encrypted object data using said first key data obtained by said obtaining means.

11. A data processing apparatus according to claim 10, wherein each of said plurality of object data in said data stream received by said receiving means is coded.

12. A data processing apparatus according to claim 10, further comprising decoding means for decoding the individual object data demultiplexed by said demultiplexing means and the object data descrambled by said descrambling means.

13. A data processing apparatus according to claim 12, wherein the plurality of object data decoded by said decoding means includes at least image data, said data processing apparatus further comprising display means for displaying said image data.

14. A data processing apparatus according to claim 10, wherein said first key data periodically changes.

15. A data processing apparatus according to claim 10, wherein said data stream includes intellectual property management and protection (IPMP) data for protecting an intellectual property right of the encrypted object data.

16. A data processing apparatus according to claim 11, wherein each of said plurality of object data in said data stream received by said receiving means is coded by a coding method conforming to MPEG-4.

17. A data processing apparatus according to claim 10, wherein the data stream includes information associated with said first key data, and the information associated with said first key data is generated by encrypting said first key data using second key data.

18. A data processing apparatus according to claim 17, wherein said seed information includes information generated by encrypting said second key data using third key data.

19. A data processing apparatus according to claim 18, wherein said seed information includes information generated by encrypting said third key data using fourth key data.

20. A data processing method comprising the steps of:
a) inputting a plurality of object data;
b) encrypting at least a predetermined portion of the object data using first key data to produce encrypted object data;
c) generating seed information which allows said first key data to be obtained therefrom;
d) multiplexing said plurality of object data and the encrypted object data to generate a data stream; and
e) individually transmitting said seed information and said data stream.

21. A data processing method according to claim 20, further comprising the step of encrypting said first key data using second key data, wherein the multiplexing step includes multiplexing the encrypted first key data.

22. A data processing method according to claim 21, further comprising the step of encrypting said second key data using third key data, wherein the encrypted second key data is included in said seed information.

23. A data processing method according to claim 22, further comprising the step of encrypting said third key data using fourth key data, wherein the encrypted third key data is included in said seed information.

24. A data processing method according to claim 20, wherein said data stream includes intellectual property management and protection (IPMP) data for protecting an intellectual property right of the encrypted object data.

25. A data processing method comprising the steps of:
a) individually receiving a data stream and seed information, said data stream having been generated by the multiplexing of a plurality of object data including object data encrypted using first key data, said seed information allowing said first key data, which is required to descramble the encrypted object data, to be obtained therefrom;
b) demultiplexing said data stream received in said receiving step into individual object data;
c) obtaining said first key data from said seed information received in said receiving step; and
d) descrambling the encrypted object data using said first key data obtained in said obtaining step.

26. A data processing method according to claim 25, wherein said data stream includes intellectual property management and protection (IPMP) data for protecting an intellectual property right of the encrypted object data.

27. A data processing method according to claim 25, wherein the data stream includes information associated with said first key data, and the information associated with said first key data is generated by encrypting said first key data using second key data.

28. A data processing method according to claim 27, wherein said seed information includes information generated by encrypting said second key data using third key data.

29. A data processing method according to claim 28, wherein said seed information includes information generated by encrypting said third key data using fourth key data.

30. A computer readable storage medium storing program code for performing a data processing method comprising the steps of:
a) inputting a plurality of object data;
b) encrypting at least a predetermined portion of the object data using first key data to produce encrypted object data;
c) generating seed information which allows said first key data to be obtained therefrom;
d) multiplexing said plurality of object data and the encrypted object data to generate a data stream; and
e) individually transmitting said seed information and said data stream.

31. A computer readable storage medium storing program code for performing a data processing method comprising the steps of:
a) individually receiving a data stream and seed information, said data stream having been generated by the multiplexing of a plurality of object data including object data encrypted using first key data, said seed information allowing said first key data, which is required to descramble the encrypted object data, to be obtained therefrom;
b) demultiplexing said data stream received in said receiving step into individual object data;
c) obtaining said first key data from said seed information received in said receiving step; and
d) descrambling the encrypted object data using said first key data obtained in said obtaining step.

32. A software program comprising program code for performing a data processing method comprising the steps of:
a) inputting a plurality of object data;
b) encrypting at least a predetermined portion of the object data using first key data to produce encrypted object data;
c) generating seed information which allows said first key data to be obtained therefrom;
d) multiplexing said plurality of object data and the encrypted object data to generate a data stream; and
e) individually transmitting said seed information and said data stream.

33. A software program comprising program code for performing a data processing method comprising the steps of:
a) individually receiving a data stream and seed information, said data stream having been generated by the multiplexing of a plurality of object data including object data encrypted using first key data, said seed information allowing said first key data, which is required to descramble the encrypted object data, to be obtained therefrom;
b) demultiplexing said data stream received in said receiving step into individual object data;
c) obtaining said first key data from said seed information received in said receiving step; and
d) descrambling the encrypted object data using said first key data obtained in said obtaining step.
